(19) United States
(12) Patent Application Publication
(10) Pub. No.: US 2005/0182848 A1
(43) Pub. Date: Aug. 18, 2005

(54) Rate limiting using pause frame capability

(76) Inventors: Roy McNeil JR., Warwick, NY (US); David Michael Colven, Dallas, TX (US); Alex Cefalu, Boonton, NJ (US); Michael Bottiglieri, River Vale, NJ (US)

Correspondence Address: SWIDLER BERLIN LLP, 3000 K STREET, NW, BOX IP, WASHINGTON, DC, 20007, US

(21) Appl. No.: 10/745,585

(22) Filed: Dec. 29, 2003

(51) Int. Cl. G06F 15/16

(52) U.S. Cl. 709/235; 709/236

(57) ABSTRACT

A system and method provides a rate limiting technique in which user traffic is not thrown away and which provides improved performance over conventional techniques. A method of rate limiting in a Local Area Network/Wide Area Network interface comprises the steps of receiving data from the Local Area Network, storing the received data in a first buffer, transmitting the received data from the first buffer to the Wide Area Network, transmitting a PAUSE frame to the Local Area Network to cause the Local Area Network to stop transmitting data, if the first buffer fills to an upper threshold, and transmitting a PAUSE frame with PAUSE=0 to the Local Area Network to cause the Local Area Network to start transmitting data, if the first buffer empties to an lower threshold.

### FIELD OF THE INVENTION

The present invention relates to a system and method for rate limiting using PAUSE frame capability in a Local Area Network/Wide Area Network interface.

### BACKGROUND OF THE INVENTION

Synchronous optical network (SONET) is a standard for optical telecommunications that provides the transport infrastructure for worldwide telecommunications. SONET offers cost-effective transport both in the access area and core of the network. For instance, telephone or data switches rely on SONET transport for interconnection.

In a typical application, a local area network (LAN), such as Ethernet, is connected to a wide area network (WAN), such as that provided by SONET. In many applications, the data bandwidth of the LAN is greater than that of the WAN. For example, a common application is known as Ethernet over SONET, in which Ethernet LAN traffic is communicated using a SONET channel. The Ethernet LAN is typically 100 Base-T, which has a bandwidth of 100 mega-bits-per-second (Mbps), while the connected SONET channel may be STS-1, which has a bandwidth of 51.840 Mbps. In such an application, the peak rate of data traffic to be communicated over the WAN from the LAN may exceed the bandwidth of the WAN; typically, the average rate of data traffic will not exceed the bandwidth of the WAN. In this situation, data traffic may be buffered to “smooth out” the peaks in data traffic so that the WAN can handle the traffic.

However, in some situations, the data traffic rate on the LAN may be high enough, for long enough, that the buffers may fill up. In this case, the rate of traffic communicated over the WAN from the LAN must be limited. Conventional systems provide rate limiting by throwing away user traffic, such as by dropping frames. This greatly affects the throughput of the system, since the thrown away traffic must be re-transmitted by the source of the traffic and with many common protocols, such as TCP and UDP, the process of recovering from throwing away traffic is also time consuming. Thus, a need arises for a rate limiting technique in which user traffic is not thrown away and which provides improved performance over conventional techniques.

### SUMMARY OF THE INVENTION

The present invention provides a rate limiting technique in which user traffic is not thrown away and which provides improved performance over conventional techniques. The present invention couples rate limiting with flow control using PAUSE frames, which allows buffers to fill and then generate flow control to the attached switch or router preventing frame drops.

In one embodiment of the present invention, a method of rate limiting in a Local Area Network/Wide Area Network interface comprises the steps of receiving data from the Local Area Network, storing the received data in a first buffer, transmitting the received data from the first buffer to the Wide Area Network, transmitting a PAUSE frame to the Local Area Network to cause the Local Area Network to stop transmitting data, if the first buffer fills to an upper threshold, and transmitting a PAUSE frame with PAUSE=0 to the Local Area Network to cause the Local Area Network to start transmitting data, if the first buffer empties to an lower threshold.

In one aspect of the present invention, the method further comprises the step of storing the data received from the Local Area Network in a second buffer in a Level 2 Switch before storing the received data in the first buffer. The method may further comprise the steps of transmitting a PAUSE frame to the Level 2 Switch to cause the Level 2 Switch to stop transmitting data, if the first buffer fills to an upper threshold and transmitting a PAUSE frame with PAUSE=0 to the Level 2 Switch to cause the Level 2 Switch to start transmitting data, if the first buffer empties to an lower threshold. The method may further comprise the steps of transmitting a PAUSE frame to the Local Area Network to cause the Local Area Network to stop transmitting data, if the second buffer fills to an upper threshold and transmitting a PAUSE frame with PAUSE=0 to the Local Area Network to cause the Local Area Network to start transmitting data, if the second buffer empties to an lower threshold.

The data received from the Local Area Network may be at a first data rate, the data transmitted from the Wide Area Network may be at a second data rate, and the first data rate may be higher than the second data rate.

The Local Area Network may be an Ethernet network and the Wide Area Network may be a Synchronous Optical Network or a Synchronous Digital Hierarchy network.

### BRIEF DESCRIPTION OF THE DRAWINGS

FIG. 1 is an exemplary block diagram of a system 100 in which the present invention may be implemented.

FIG. 2 is an exemplary block diagram of an optical LAN/WAN interface service unit.

FIG. 3 is an exemplary flow diagram of a process of operation of the service unit shown in FIG. 2, implementing rate limiting using PAUSE frames.

FIG. 4 is an exemplary data flow diagram of data within the service unit shown in FIG. 2, implementing rate limiting using PAUSE frames.

FIG. 5 is an exemplary logical block diagram that implements two number rate limiting.

FIG. 6 is a process of operation of two number rate limiting.

FIG. 7 is an exemplary block diagram of an embodiment of rate limiting.

### DETAILED DESCRIPTION OF THE PREFERRED EMBODIMENT

The rate limiter pulls data from the main Tx buffer. If the input data rate exceeds the WAN output data rate, then the buffer will fill. When the buffer reaches a pre-set threshold (high watermark) then flow control is initiated—PAUSE frames are sent to the attached router or switch to prevent further frames from being sent. When the Tx drains to a point where a low watermark threshold is crossed, then flow control is de-activated by sending a second PAUSE frame which causes the attached router or switch to start sending traffic again.

The fact that it resides on the output side of the buffers is advantageous in that it can be used in conjunction with the PAUSE mechanism to effectively throttle back on a customer's incoming traffic in a lossless fashion. It also provides the flexibility in billing the customer for smaller quantities of bandwidth, with an easy growth path up to the full line rate of his/her Ethernet port of 100 Mbps or 1 Gbps, whatever the case may be.

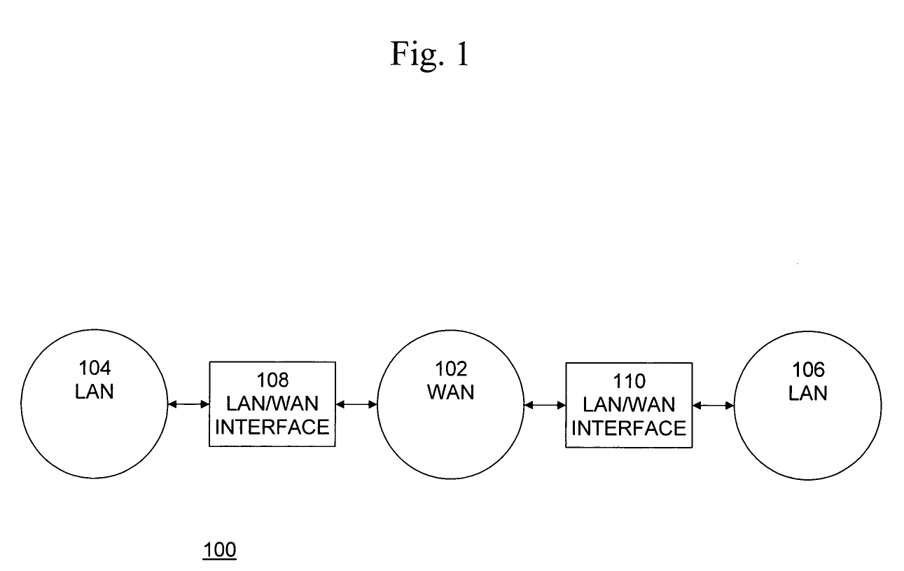

An exemplary block diagram of a system 100 in which the present invention may be implemented is shown in FIG. 1. System 100 includes a Wide Area Network 102 (WAN), one or more Local Area Networks 104 and 106 (LAN), and one or more LAN/WAN interfaces 108 and 110. A LAN, such as LANs 104 and 106, is computer network that spans a relatively small area. Most LANs connect workstations and personal computers. Each node (individual computer) in a LAN has its own CPU with which it executes programs, but it also is able to access data and devices anywhere on the LAN. This means that many users can share expensive devices, such as laser printers, as well as data. Users can also use the LAN to communicate with each other, by sending e-mail or engaging in chat sessions.

There are many different types of LANs, Ethernets being the most common for Personal Computers (PCs). Most LANs are confined to a single building or group of buildings. However, one LAN can be connected to other LANs over any distance via longer distance transmission technologies, such as those included in WAN 102. A WAN is a computer network that spans a relatively large geographical area. Typically, a WAN includes two or more local-area networks (LANs), as shown in FIG. 1. Computers connected to a wide-area network are often connected through public networks, such as the telephone system. They can also be connected through leased lines or satellites. The largest WAN in existence is the Internet.

Among the technologies that may be used to implement WAN 102 are optical technologies, such as Synchronous Optical Network (SONET) and Synchronous Digital Hierarchy (SDH). SONET is a standard for connecting fiber-optic transmission systems. SONET was proposed by Bellcore in the middle 1980s and is now an ANSI standard. SONET defines interface standards at the physical layer of the OSI seven-layer model. The standard defines a hierarchy of interface rates that allow data streams at different rates to be multiplexed. SONET establishes Optical Carrier (OC) levels from 51.8 Mbps (about the same as a T-3 line) to 2.48 Gbps. Prior rate standards used by different countries specified rates that were not compatible for multiplexing. With the implementation of SONET, communication carriers throughout the world can interconnect their existing digital carrier and fiber optic systems.

SDH is the international equivalent of SONET and was standardized by the International Telecommunications Union (ITU). SDH is an international standard for synchronous data transmission over fiber optic cables. SDH defines a standard rate of transmission at 155.52 Mbps, which is referred to as STS-3 at the electrical level and STM-1 for SDH. STM-1 is equivalent to SONET's Optical Carrier (OC) levels −3.

LAN/WAN interfaces 108 and 110 provide electrical, optical, logical, and format conversions to signals and data that are transmitted between a LAN, such as LANs 104 and 106, and WAN 102.

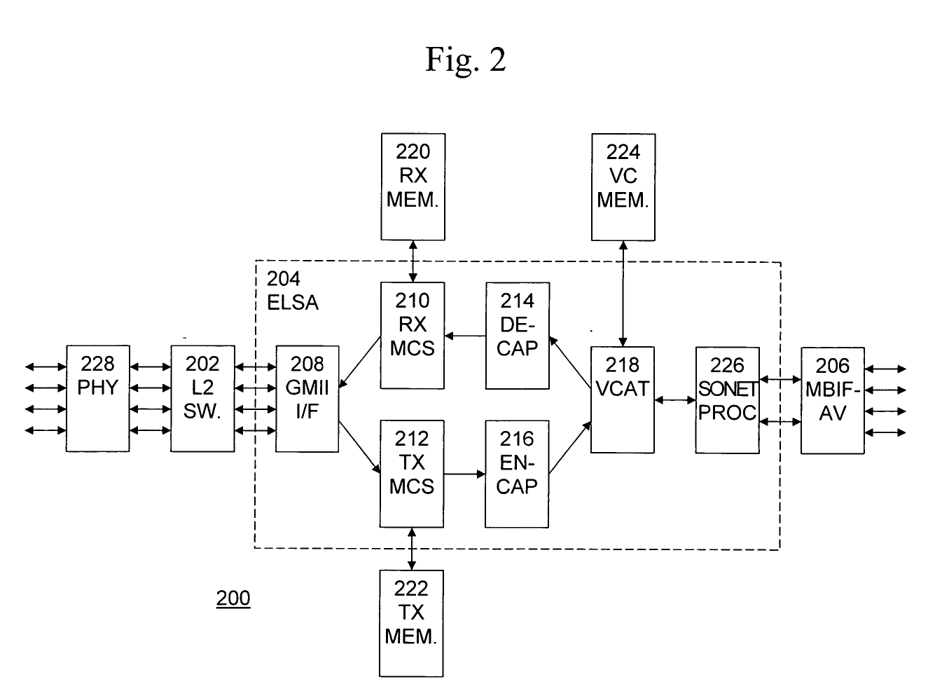

An exemplary block diagram of an optical LAN/WAN interface service unit 200 (SU) is shown in FIG. 2. A typical SU interfaces Ethernet to a SONET or SDH network. For example, a Gig/100BaseT Ethernet SU may provide Ethernet over SONET (EOS) services for up to 4 Gigabit Ethernet ports, (4-10/100 BaseT ports in the 100BaseT case). Each port may be mapped to a set of STS-1, STS-3c or STS-12c channels depending on bandwidth requirements. Up to 12-STS-1, 4-STS-3c or 1-STS-12c may be supported up to a maximum of STS-12 bandwidth (STS-3 with OC3 and OC12 LUs).

In addition to EOS functions, SU 200 may support frame encapsulation, such as GFP, X.86 and PPP in HDLC Framing. High Order Virtual Concatenation may be supported for up to 24-STS-1 or 8-STS-3c channels and is required to perform full wire speed operation on SU 200, when operating at 1 Gbps.

SU 200 includes three main functional blocks: Layer 2 Switch 202, ELSA 204 and MBIF-AV 206. ELSA 202 is further subdivided into functional blocks including a GMII interface 208 to Layer 2 (L2) Switch 202, receive Memory Control & Scheduler (MCS) 210 and transmit MCS 212, encapsulation 214 and decapsulation 216 functions (for GFP, X.86 and PPP), Virtual Concatenation 218, frame buffering provides by memories 220, 222, and 224, and SONET mapping and performance monitoring functions 226. MBIF-AV 206 is used primarily as a backplane interface device to allow 155 Mbps or 622 Mbps operation. In addition SU 200 includes physical interface (PHY) 228.

PHY 228 provides the termination of each of the four physical Ethernet interfaces and performs clock and data recovery, data encode/decode, and baseline wander correction for the 10/100BaseT copper or 1000Base LX or SX optical. Autonegotiation is supported as follows:
10/100BaseT—speed, duplexity, PAUSE Capability
1 GigE—PAUSE Capability (allowed for EPORT only)

PHY 228 block provides a standard GMII interface to the MAC function, which is located in L2 Switch 202.

L2 Switch 202, for purposes of EPORT and TPORT, is operated as a MAC device. L2 Switch 202 is placed in port mirroring mode to provide transparency to all types of Ethernet frames (except PAUSE, which is terminated by the MAC). L2 Switch 202 is broken up into four separate 2 port bi-directional MAC devices, which perform MAC level termination and statistics gathering for each set of ports. Support for Ethernet and Ether-like MIBs is provided by counters within the MAC portion of L2 Switch 202. L2 Switch 202 also provides limited buffering of frames in each direction (L2 Switch 202->ELSA 204 and ELSA 204->L2 Switch 202); however, the main packet storage area is the Tx Memory 222 and Rx Memory 220 attached to ELSA 204. L2 Switch 202 is capable of buffering 64 to 9216 byte frames in its limited memory. Both sides of L2 Switch 202 interface to adjacent blocks via a GMII interface.

ELSA 204 provides frame buffering, SONET Encapsulation and SONET processing functions.

In the Tx direction, the GMII interface 208 of ELSA 204 mimics PHY 228 operation at the physical layer. Small FIFOs are incorporated into GMII interface 208 to adapt bursty data flow to the Tx Memory 222 interface. Enough bandwidth is available through the GMII 208 and Tx Memory 222 interfaces (8 Gbps) to support all data transfers without frame drop for all four interfaces (especially when all four Ethernet ports are operating at 1 Gbps). The GMII interface 208 also supports the capability of flow controlling the L2 Switch 202. The GMII block 208 receives memory threshold information supplied to it from the Tx Memory Controller 212, which monitors the capacity of the Tx Memory 222 on a per port basis (per customer basis for TPORT), and is programmable to drop incoming frames or provide PAUSE frames to the L2 Switch 202 when a predetermined threshold has been reached in memory. When flow control is used, the memory thresholds are set to provide enough space to avoid dropping frames given the PAUSE frame reaction times. The GMII interface 208 must also calculate and add frame length information to the packet. This information is used for GFP frame encapsulation.

The Tx MCS 212 provides the low level interface functions to the Tx Memory 222, as well as providing scheduler functions to control pulling data from the GMII FIFOs and paying out data to the Encapsulation block 216. For practical purposes, the Tx Memory 222 is effectively a dual port RAM; so, two independent scheduler blocks are provided for reading from and writing to the Tx Memory 222. The scheduler functions for EPORT and TPORT will differ slightly, but these differences will be handled through provisioning information supplied to the scheduler.

The primary function of the Tx Memory 222 is to provide a level of burst tolerance to entering LAN data, especially in the case where the LAN bandwidth is much greater than the provisioned WAN bandwidth. A secondary function of this memory is for Jumbo frame storage; this allows cut through operation in the GMII block 208 to provide for lower latency data delivery by not buffering entire large frames. The Tx Memory 222 is typically divided into partitions, for example, one partition per port or one partition per customer (VLAN). For both cases, each partition is operated as an independent FIFO. Fixed memory sizes are chosen for each partition regardless of the number of ports or customers currently in operation. Partitioning in this fashion prevents dynamic re-sizing of memory when adding or deleting ports/customers and provides for hitless upgrades/downgrades. The memory is also sized independently of WAN bandwidth. This provides for a constant burst tolerance as specified from the LAN side (assuming zero drain rate on WAN side). This partitioning method also guarantees fair allocation of memory amongst customers.

The Encapsulation block 216 has a demand based interface to the Tx MCS 212. Encapsulation block 216 provides three types of SONET encapsulation modes, provisionable on a per port/customer basis (although SW may limit encapsulation choice on a per board basis). The encapsulation modes are:
PPP in HDLC framing
X.86
GFP (frame mode only)

In each encapsulation mode, additional overhead is added to the pseudo-Ethernet frame format stored in the Tx Memory 222.

The Encapsulation block 216 will decide which of the fields are relevant for the provisioned encapsulation mode. For example, Ethernet Frame Check Sequence (FCS) may or may not be used in Point-to-Point (PPP) encapsulation; and, length information is used only in GFP encapsulation. Another function of the Encapsulation block is to provide “Escape” characters to data that appears as High Level Data Link Control (HDLC) frame delineators (7Es) or HDLC Escape characters (7Ds). Character escaping is necessary in PPP and X.86 encapsulation modes. In the worst case, character escaping can nearly double the size of an incoming Ethernet frame; as such, mapping frames from the Tx Memory 222 to the SONET section of the ELSA 204 is non-deterministic in these encapsulation modes and requires a demand based access to the Tx Memory 222. An additional memory buffer block is housed in the Encapsulation block 216 to account for this rate adaptation issue. Watermarks are provided to the Tx MCS 212 to monitor when the scheduler is required to populate each port/customer space in the smaller memory buffer block.

The Virtual Concatenation (VCAT) block 218 takes the encapsulated frames and maps them to a set of pre-determined VCAT channels. A VCAT channel can consist of the following permutations:
Single STS-1
Single STS-3c
Single STS-12c
STS-1-Xv (X=1 . . . 24 for EPORT; X=1.3 for TPORT)
STS-3c-Xv (X=1 . . . 8 for EPORT; X=1 for TPORT)

These channel permutations provide a wide variety of bandwidth options to a customer and can be sized independently for each VCAT channel. The VCAT block 218 encodes the H4 overhead bytes required for proper operation of Virtual Concatenation. VCAT channel composition is signaled to a receive side SU using the H4 byte signaling format specified in the Virtual Concatenation standard. The VCAT block 218 provides TDM data to the SONET processing block after the H4 data has been added.

The SONET Processing block 226 multiplexes the TDM data from the VCAT block 218 into two STS-12 SONET data streams. Proper SONET overhead bytes are added to the data stream for frame delineation, pointer processing, error checking and signaling. The SONET Processing block 226 interfaces to the MBIF-AV block 206 through two STS-12 interfaces. In STS-3 mode (155 Mbps backplane interface), STS-3 data is replicated four times in the STS-12 data stream sent to the MBIF-AV 206; the first of four STS-3 bytes in the multiplexed STS-12 data stream represents the STS-3 data that is selected by the MBIF-AV 206 for transmission.

The MBIF-AV block 206 receives the two STS-12 interfaces previously described and maps them to the appropriate backplane interface LVDS pair (standard slot interface or BW Extender interface). The MBIF-AV 206 also has the responsibility of syncing SONET data to the Frame Pulse provided by the Line Unit and insuring that the digital delay of data from the frame pulse to the Line Unit is within specification. The MBIF-AV 206 block also provides the capability of mapping SONET data to a 155 Mbps or 622 Mbps LVDS interface; this allows SU 200 to interface to the OC3LU, OC12LU or OC48LU. 155 Mbps or 622 Mbps operation is provisionable and is upgradeable in system with a corresponding traffic hit. When operating as a 155 Mbps backplane interface, the MBIF-AV 206 must select STS-3 data out of the STS-12 stream supplied by the SONET Processing block and format that for transmission over the 155 Mbps LVDS links.

In the WAN-to-LAN datapath, MBIF-AV 206 is responsible for Clock and Data Recovery (CDR) for the four LVDS pairs, at either 155 Mbps or 622 Mbps.

The MBIF-AV 206 also contains a full SONET framing function; however, for the most part, the framing function serves as an elastic store element for clock domain transfer that is performed in this block. SONET Processing that is performed in this block is as follows:
A1, A2 alignment (provides pseudo-frame pulse to SONET Processing block to indicate start of frame)
B1 error monitoring (indicates any backplane errors that may have occurred)

Additional SONET processing is provided in the SONET Processing block 226. Multiplexing of Working/Protect channels from the standard slot interface or Bandwidth Extender slot interface is also provided in the MBIF-AV block 206. Working and Protect selection is chosen under MCU control. After the proper working/protect channels have been selected, the MBIF-AV block 206 transfers data to the SONET Processing block through one or both STS-12 interfaces. When operating at 155 Mbps, the MBIF-AV 206 has the added responsibility of multiplexing STS-3 data into an STS-12 data stream which is supplied to the SONET Processing block 226.

On the receive side, the SONET Processing block 226 is responsible for the following SONET processing:
Path Pointer Processing
Path Performance Monitoring
RDI, REI processing
Path Trace storage

In STS-3 mode of operation (155 Mbps backplane interface), a single stream of STS-3 data must be plucked from the STS-12 data stream as it enters the SONET Processing block 226. The SONET Processing block 226 selects the first of the four interleaved STS-3 bytes to reconstruct the data stream. After SONET Processing has been completed, TDM data is handed off to the VCAT block 218.

The VCAT block 218 processing is a bit more complicated on the receive side because the various STS-1 or STS-3c channels that comprise a VCAT channel may come through different paths in the network—causing varying delays between SONET channels. The H4 byte is processed by the VCAT block to determine:
STS-1 or STS-3c channel sequencing
Delays between SONET channels

This information is learned over the course of 16 SONET frames to determine how the VCAT block 218 should process the aggregate VCAT channel data. As data on each STS-1 or STS-3c is received, it is stored in VC Memory 224. Skews between each STS-1 or STS-3c are compensated for by their relative location in VC Memory 224 based on delay information supplied in the H4 information for each channel. The maximum skew between any two SONET channels is determined by the depth of the VC Memory 224. Bytes of data are spread one-by-one across each of the SONET channels that are members of a VCAT channel; so, if one SONET channel is lost, no data will be supplied through the aggregate VCAT channel.

The Decapsulation block 214 pulls data out of the VC Memory 224 based on sequencing information supplied to it by the VCAT block 218. Data is pulled a byte at a time from different address locations in VC Memory 224 corresponding to each received SONET channel that is a member of the VCAT channel. The Decapsulation block 214 is a Time Division Multiplex (TDM) block that is capable of supporting multiple instances of VCAT channels (up to 24 in the degenerate case of all STS-1 SONET channels) as well as multiple encapsulation types, simultaneously. Decapsulation of PPP in HDLC framing, X.86 and GFP (frame mode) are all supported. The Decapsulation block 214 strips all encapsulation overhead data from the received SONET data and provides raw Ethernet frames to the Rx MCS 210. If Ethernet FCS data was stripped by the transmit side Encap block 216 (option in PPP), then it is also added in the Decap block 214. Length information, used by GFP, will be stripped in this block.

Rx MCS 210 receives data from the Decapsulation block 214. In TPORT mode, the Rx Memory Controller block inserts a VLAN tag corresponding to the VCAT channel associated with a particular customer.

The scheduling function required for populating Rx Memory 220 from the SONET side is straightforward. As the Decapsulation block 214 provides data to Rx MCS 210, it writes the corresponding data to memory 220 in the order that it was received. There is a clock domain transfer from the Decapsulation block 214 to Rx MCS 210; so, a small amount of internal buffering is provided for rate adaptation within the ELSA 204. Through provisioning information, Rx MCS 210 creates associations of VCAT channels to memory locations. In the case of EPORT, four memory partition locations are supported, one for each possible LAN port. Data in each memory partition is organized and controlled as a FIFO.

The algorithm for scheduling data from the Rx Memory 220 to corresponding LAN ports is essentially a token-based scheduling scheme. Ports/customers are given a relative number of tokens based on the bandwidth that they are allocated on the WAN side. So, an STS-3c channel is allocated three times as many tokens as an STS-1 channel. Tokens are refreshed for each port/customer on a regular basis. When the tokens reach a predetermined threshold, a port/customer is allowed to transfer data onto the appropriate LAN port. If the threshold is not reached, additional token replenishment is required before data can be sent. This algorithm takes into account the relative size of frames (byte counts) as well as the allocated WAN bandwidth for a particular port/customer. Each port/customer receives a fair share of LAN bandwidth proportional to the WAN bandwidth that was provisioned.

The scheduler function also takes into account the possibility of WAN oversubscription. Since it is possible to provision an STS-24 worth of bandwidth, care must be taken when mapping this amount of bandwidth onto a 1 Gbps LAN link; maintaining fairness of bandwidth allocation among ports/customers is key. The scheduler algorithm provides fair distribution of bandwidth under these conditions. In the case where WAN oversubscription is persistent, Rx Memory 220 will fill and eventually data will be discarded; however, it will be discarded fairly, based on the amount of memory that each port/customer was provisioned.

As with the Tx Memory 222, the Rx Memory 220 is partitioned in the same manner. For EPORT, four partitions are created. Each port/customer will get an equal share of memory.

The GMII interface 208 provides the interface to the L2 switch 202 as described earlier for the Tx direction. In the Rx direction, the GMII interface 208 supplies PAUSE data as part of the data stream when the GMII has determined that watermarks were crossed in the Tx Memory 222.

The L2 Switch 202 operates the same in the Rx direction as in the Tx direction. It is completely symmetrical and uses port mirroring in this direction as well. It may receive PAUSE frames from the GMII I/F 208 in the ELSA 204, in which case, it will stop sending data to the ELSA 204. In turn, the L2 Switch 202 memory may fill (in the Tx direction) and eventually packets will be dropped, or the L2 Switch 202 will generate PAUSE to the attached router or switch. The L2 Switch 202 supplies the PHY 228 with GMII formatted data.

The PHY 228 converts the GMII information into appropriately coded information and performs a parallel to serial conversion and transfers the data out onto the respective LAN port.

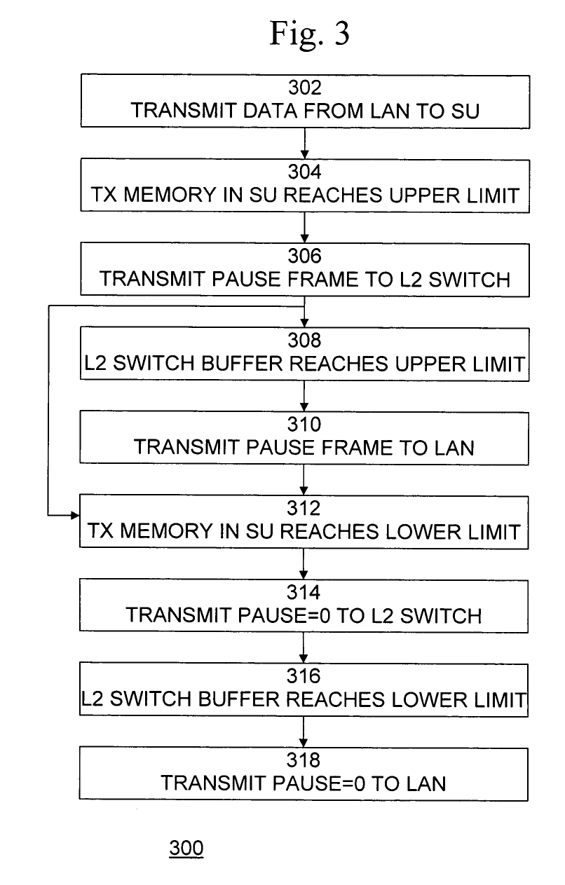

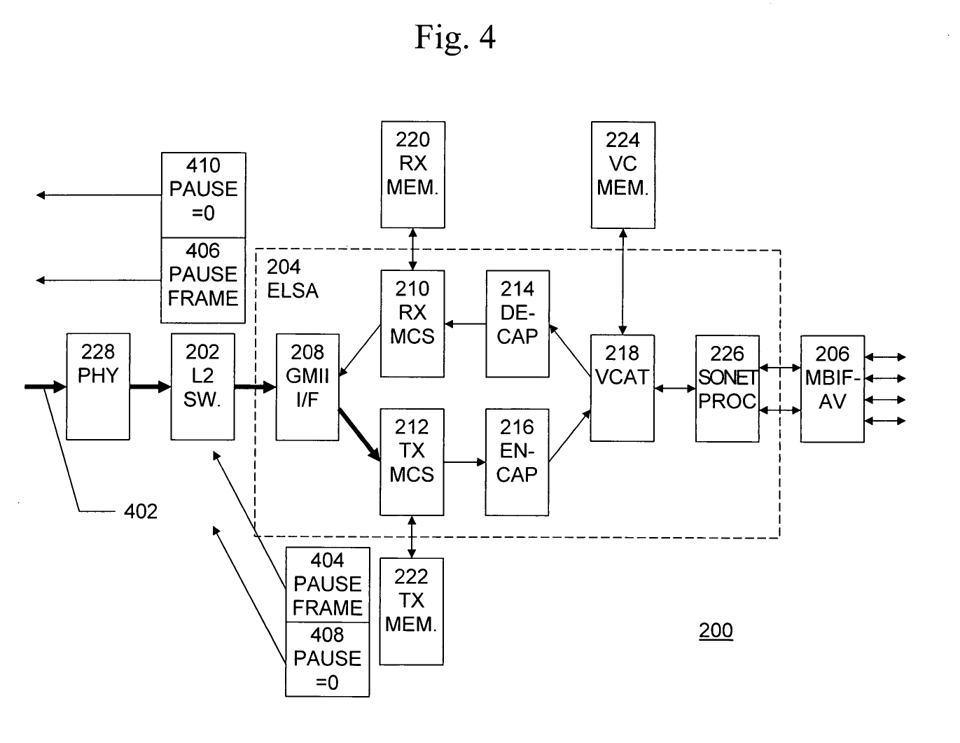

A process 300 of operation of SU 200, implementing rate limiting using PAUSE frames, is shown in FIG. 3. It is best viewed in conjunction with FIG. 4, which is a data flow diagram of data within SU 200. Process 300 begins with step 302, in which data 402 is transmitted from a LAN, such as Ethernet, to a SONET network via SU 200. The data is transmitted through PHY 228, L2 Switch 202, GMII interface 208, Tx MCS 212, Encapsulation block 216, VCAT block 218, SONET processing block 226, and MBIF-AV block 206. As the data is transmitted through SU 200, the data is buffered by Tx Memory 222 and by buffers included in L2 Switch 202. If the data throughput rate of the SONET channel connected to MBIF-AV block 206 is less than the data throughput rate of the LAN connected to PHY 228, the buffer in Tx Memory 222, in which the data is being buffered, may, in step 304 become “full”, where full is defined as reaching an upper limit or threshold of storage within Tx Memory 222.

If the upper storage limit within Tx Memory 222 is reached in step 304, then in step 306, a pause frame 404 is transmitted from Tx MCS 212 to L2 Switch 202. Upon receiving pause frame 404, L2 Switch 202 stops transmitting data to Tx MCS 212. With L2 Switch 202 not transmitting data, Tx Memory 222 begins to empty, while the buffers included in L2 Switch 202 begin to fill.

If there is a large data throughput mismatch, the buffers in L2 Switch 202 may, in step 308, themselves reach an upper limit or threshold of storage. If the upper storage limit of the buffers in L2 Switch 202 is reached in step 308, then, in step 310, a pause frame 406 is transmitted from L2 Switch 202 to the LAN through PHY 228. Upon receiving the pause frame, the LAN stops transmitting data to SU 200.

After step 310, with the LAN not transmitting data, L2 Switch 202 not transmitting data, and Tx Memory 222 emptying, in step 312, Tx Memory 222 will reach its lower limit. Likewise, after step 306, with L2 Switch 202 not transmitting data and Tx Memory 222 emptying, if the data throughput mismatch is not too large or too sustained, in step 312, Tx Memory 222 will reach its lower limit. In response, in step 314, a pause frame 408 with PAUSE=0 is transmitted from Tx MCS 212 to L2 Switch 202. Upon receiving pause frame 408 with PAUSE=0, L2 Switch 202 begins transmitting data to Tx MCS 212.

With L2 Switch 202 transmitting data, the buffers in L2 Switch 202 begin to empty. Eventually, in step 316, the buffers in L2 Switch 202 reach their lower limit. In response, a pause frame 410 with PAUSE=0 is transmitted from L2 Switch 202 to the LAN through PHY 228. Upon receiving pause frame 410 with PAUSE=0, the LAN begins transmitting data to SU 200.

It will be understood by those of skill in the art that there are other embodiments that may provide similar advantages to the described embodiments. For example, one of skill in the art would recognize that rate limiting using PAUSE frames may be advantageously applied to SDH networks, as well as SONET networks. Likewise, for another example, the technique shown in FIGS. 3 and 4 may also be applied to limiting traffic flow over the WAN connected to SU 200. PAUSE frames may be transmitted to the WAN via MBIF-AV 206 to stop and start the transmission of traffic at the far end of the WAN. This technique may be useful, although the transmission PAUSE over the WAN is essentially a feedback loop with a long delay and no control over the delay. In addition, additional memory may be added to SU 200 to provide the capability for traffic shaping beyond that provided by the above-described upper and lower thresholds. The traffic shaping may be controlled by additional parameters and may result in a smoother flow of traffic through the network.

The use of two numbers to control rate limiting makes the problem linear and requires shallow counters. Use of a ratio scheme between two numbers provides a more exact rate limit. In general, rate limits are for 10/100 Meg/Ethernet from 1 in increments of 1 (1 . . . 10/100). For 1000 Meg/Ethernet from 10 in increments of 10 (10 . . . 1000).

Two parameters that are software derived are n and m, as shown in the following general relationship:
Let R=the rate to which the WAN is limited
Let L=the LAN input rate (10/100/1000)
Then, R=m/(n+m)*L

If m=Rd(limit Rate desired) and n=L−Rd, then m and n will be integers that give the desired results (when L and Rd are integers).

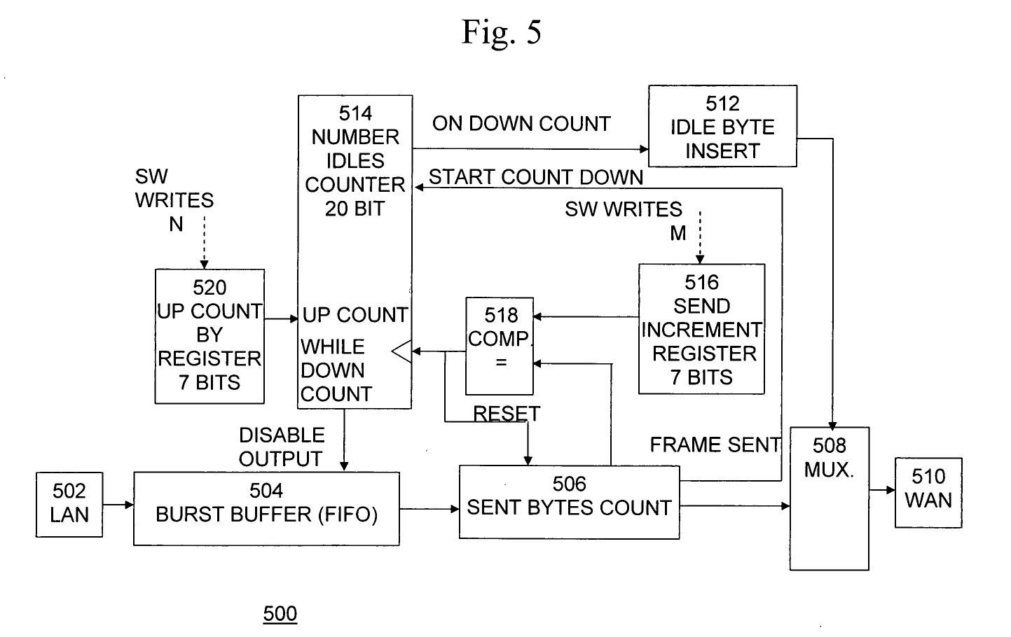

An exemplary logical block diagram 500 that implements two number rate limiting is shown in FIG. 5. LAN 502 transmits data that is stored in burst buffer 504. Send bytes counter 506 counts the number of bytes of the data stored in burst buffer 504 that are sent to WAN 508. The bytes sent to WAN 508 are sent through multiplexer 510, which either passes through the bytes from burst buffer 504 or idle bytes generated by idle byte insert 512. Idle bytes are sent to WAN 510 when the output of burst buffer 504 is disabled by number idles counter 514. Number idles counter 514 counts when the value in sent bytes count 506 equals the value stored in send increment register 516. The detection of this equality by comparator 518 causes number idles counter 514 to count and also resets sent bytes count 506. Number idle bytes counter 514 counts up or down depending upon whether sent bytes count 506 indicates that a frame has been sent to WAN 510. While number idles counter 514 is counting down, burst buffer 504 is disabled and idle bytes are sent to WAN 510. While number idles counter 514 is counting up, the increment by which number idles counter 514 counts up is set by the value in up count by register 512. The parameter n is input to up count by register 520 and the parameter m is input to send increment register 516.

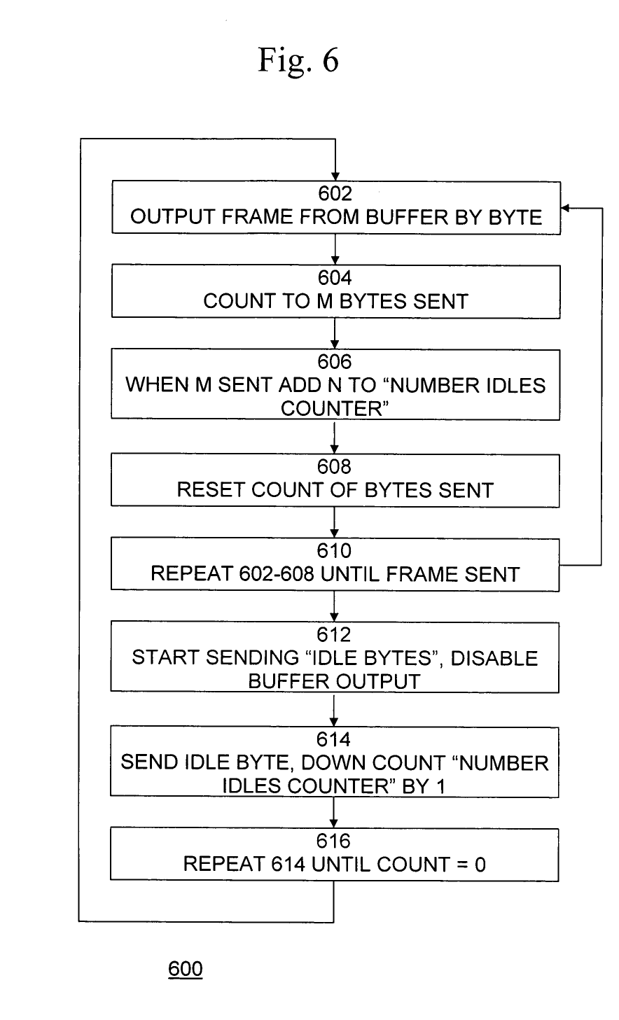

A process of operation 600 of two number rate limiting is shown in FIG. 6. It is best viewed in conjunction with FIG. 5. Process 600 begins with step 602 in which a data frame is output byte by byte from burst buffer 504 and sent by multiplexer 508 to WAN 510. In step 604, bytes are sent until sent bytes count 506 equals the value m stored in send increment register 516. In step 606, when sent bytes count 506 equals the value m stored in send increment register 516, as determined by comparator 518, number idles counter 514 is incremented by the value n stored in up count by register 512. In step 608, sent bytes count 506 is reset and thus, the count is restarted. In step 610, steps 602-608 are repeated until the entire frame has been sent. Sent bytes count 506 then indicates that the entire frame has been sent. In step 612, idle bytes are sent by multiplexer 508 to WAN 510 and the output of data from burst buffer 504 is disabled. In step 614, idle bytes are sent and number idles counter 514 is decremented by one for each idle byte sent. In step 616, step 614 is repeated until number idles counter 514 reaches zero; then the process loops back to step 602 and repeats.

In general SE/planning agreement that rate limits are for 10/100 from 1 in increments of 1 (1 . . . 10/100). For 1000 from 10 in increments of 10 (10 . . . 1000). From the block diagram two parameters that are software derived are n and m. The general relationship is as follows:
Let R=the rate to which the WAN is limited.
Let L=the LAN input rate (10/100/1000)
R=m/(n+m)*L (per the described circuit)

Then, if m=Rd(limit Rate desired) and n=L−Rd, m and n will be integers that give the desired results (when L and Rd are integers)
For 10/100/1000 baseT the ranges are:
10Base
   Min m=1 (Rmin), Max m=10 (Rmax)
   Min n=0 (L−Rmax), Max n=9 (L−Rmin)
100Base
   Min m=1 (Rmin), Max m=100 (Rmax)
   Min n=0 (L−Rmax), Max n=99 (L−Rmin)
1000Base
   Min m=10 (Rmin), Max m=1000 (Rmax)
   Min n=0 (L−Rmax), Max n=990 (L−Rmin)
However we can scale by 10 for 1000 and use n′=n/10 (0,99) and m′=m/10 (1,100).
Therefore: n and m are less than 7 bits
   This counter contains the maximum number of Idle bytes that must be inserted for a frame The highest ratio is max n/max m=99 The longest frame ˜10000 bytes (jumbo frame) Thus “Max_Idles”=99*10,000˜10E6 This is less than 20 bits. In the “real” world the WAN rate and the LAN rate are not equal In this case the formula replaces L with W and R remains the same Since m=R the range of m is unchanged Since n=L then n=w but the range becomes min n=(Wmax−Rmin)=? The max value of W for the DMLAN is ˜OC3 Thus Max n˜155<256 and requires 8 bits This is also sufficient to cover the STS1 case In the future there may be arguments for a 1 meg granularity from 100 Bt or 1G onto STS24. This would require Max n of 11 bits and a max “Idle Count” of 10,000*1244=24 bits.

Mathematically any algorithm that uses a single number will fall into one of two types:
1) R=(m)/(m+K)*W
2) R=(K)/(K+n)*W
   I.e. one of the two variables m or n is fixed. In either case all “steps” are in terms of R that is Steps are 0, R, 2R . . . (W/R)R. Because these functions of a single variable do not provide linear steps the biggest step in the function has to equate to R:
1) when m=1, m/(m+K)=1/(1+K)=R/W let R/W represent ratio L
2) when n=1, K/(K+1)=L
   For 1) the values go asymptotically closer to 1 and the last useful value is K/(K+1). Therefore Max n=K\hat{ }2. In this case L=K/(1+K)=99/100 K=99, n=99\hat{ }2=9801=14 bits.

For 2) the values go asymptotically closer to 0 and the last useful value is 1−1/(1+K)=K/(K+1). Therefore Max m=K\hat{ }2. In this case L=1/(1+K)=1/100, K=99, and m=99\hat{ }2=9801=14 bits. This works at the boundary conditions but is not a perfect match in the linear sense.

For non-integral WAN links, let W be the highest integral value of the Rate Limit on the WAN link. Small e is the remaining BW.
Rr(real)=m/(n+m)*(W+e)
Rd(desired)=m/(n+m)*W
   Therefore: Rr/Rd=1+e/W always slightly higher but this makes the average rate closer max error<1 Mbit in 51˜2%.

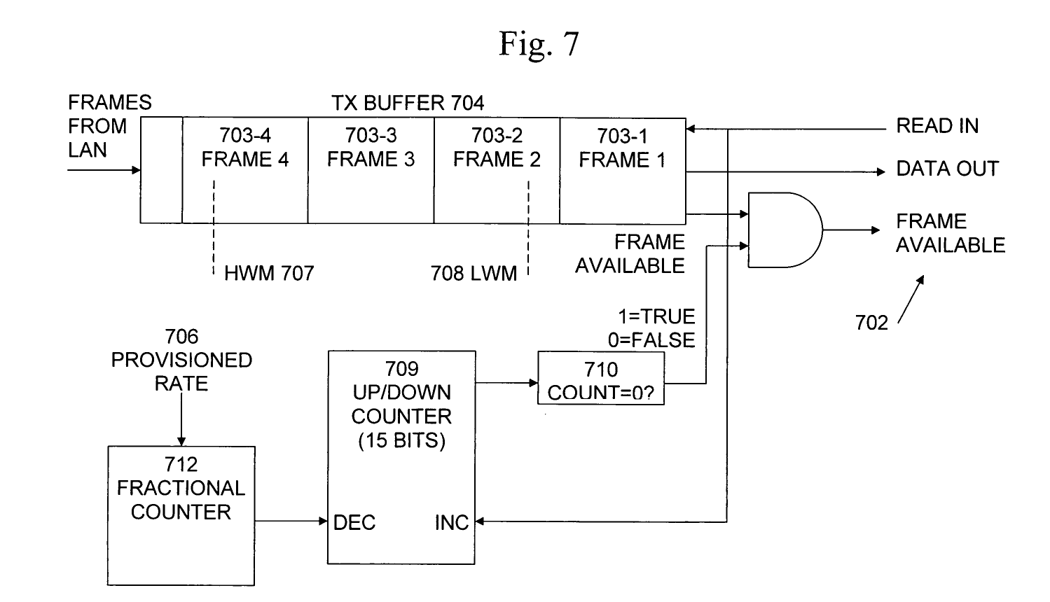

An example of another embodiment of Rate Limiting is shown in FIG. 7. This embodiment is based upon a debit based approach, with a frame level handshake 702 on the WAN side. Frames 703-1, 703-2, 703-3, and 703-4 are stored in the TX buffer 704, and are paid out at a provisioned rate 706 that takes into account the difference in clock rates between the LAN interface and the SONET interface. High water mark (HWM) 707 and low water mark (LWM) 708 are used to control the PAUSE mechanism for lossless transmission of frames at the provisioned rate, where the provisioned rate is less than the arrival rate from the LAN. This method exploits the fact that the SONET interface will draw from the TX buffer 704 on a frame level handshake 702, adapting the variably sized Ethernet frames into the SONET SPE.

The debit based approach differs from the aforementioned credit based approach in that it is frame aware and does not rely on an idle insert method, but rather continually counts down at the provisioned rate 706, for example, in provisioned multiples of 10,000000 bits per second. The debit based approach only allows the SONET interface to read entire frames from the TX buffer when the UP/DOWN counter 708 is equal to zero 710. The variability in the Ethernet frame sizes is handled by counting up on a per byte basis. Idle time on the LAN interface is not credited, as the UP/DOWN counter 709 does not decrement below zero. The fact that credits are not built up for intervals where the LAN side is not transmitting frames does not adversely affect the average rate transmitted over the SONET WAN, as idle periods of time on the LAN interface will fall below the provisioned rate anyway. The frame level handshake 702 on the SONET side ensures that number of bytes transmitted over time is accurately captured, and yields a smoothing effect on the traffic that generates a frame gap to the SONET interface that is proportional to the size of the last frame transmitted in conjunction with the provisioned rate. This implementation requires a single provisioned value which determines the multiple of discrete quanta, such as in 10,000,000 bit/sec quanta, to rate limit out to the SONET interface. The accuracy is achieved via cascaded fractional dividers 712 which adapt the quanta into the SONET domain.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method of rate limiting in a Local Area Network/Wide Area Network interface comprising the steps of:
receiving data from the Local Area Network;
storing the received data in a first buffer;
transmitting the received data from the first buffer to the Wide Area Network;
transmitting a PAUSE frame to the Local Area Network to cause the Local Area Network to stop transmitting data, if the first buffer fills to an upper threshold; and
transmitting a PAUSE frame with PAUSE=0 to the Local Area Network to cause the Local Area Network to start transmitting data, if the first buffer empties to an lower threshold.

2. The method of claim 1, wherein the method further comprises the step of:
storing the data received from the Local Area Network in a second buffer in a Level 2 Switch before storing the received data in the first buffer.

3. The method of claim 2, wherein the method further comprises the steps of:
transmitting a PAUSE frame to the Level 2 Switch to cause the Level 2 Switch to stop transmitting data, if the first buffer fills to an upper threshold; and
transmitting a PAUSE frame with PAUSE=0 to the Level 2 Switch to cause the Level 2 Switch to start transmitting data, if the first buffer empties to an lower threshold.

4. The method of claim 3, wherein the method further comprises the steps of:
transmitting a PAUSE frame to the Local Area Network to cause the Local Area Network to stop transmitting data, if the second buffer fills to an upper threshold; and
transmitting a PAUSE frame with PAUSE=O to the Local Area Network to cause the Local Area Network to start transmitting data, if the second buffer empties to an lower threshold.

5. The method of claim 4, wherein the data received from the Local Area Network is at a first data rate.

6. The method of claim 5, wherein the data transmitted from the Wide Area Network is at a second data rate.

7. The method of claim 6, wherein the first data rate is higher than the second data rate.

8. The method of claim 7, wherein the Local Area Network is an Ethernet network.

9. The method of claim 8, wherein the Wide Area Network is a Synchronous Optical Network or a Synchronous Digital Hierarchy network.

10. A system of rate limiting in a Local Area Network/Wide Area Network interface comprising:
means for receiving data from the Local Area Network;
means for storing the received data in a first buffer;
means for transmitting the received data from the first buffer to the Wide Area Network;
means for transmitting a PAUSE frame to the Local Area Network to cause the Local Area Network to stop transmitting data, if the first buffer fills to an upper threshold; and
means for transmitting a PAUSE frame with PAUSE=0 to the Local Area Network to cause the Local Area Network to start transmitting data, if the first buffer empties to an lower threshold.

11. The system of claim 10, wherein the system further comprises:
means for storing the data received from the Local Area Network in a second buffer in a Level 2 Switch before storing the received data in the first buffer.

12. The system of claim 11, wherein the system further comprises:
means for transmitting a PAUSE frame to the Level 2 Switch to cause the Level 2 Switch to stop transmitting data, if the first buffer fills to an upper threshold; and
means for transmitting a PAUSE frame with PAUSE=0 to the Level 2 Switch to cause the Level 2 Switch to start transmitting data, if the first buffer empties to an lower threshold.

13. The system of claim 12, wherein the system further comprises:
means for transmitting a PAUSE frame to the Local Area Network to cause the Local Area Network to stop transmitting data, if the second buffer fills to an upper threshold; and
means for transmitting a PAUSE frame with PAUSE=0 to the Local Area Network to cause the Local Area Network to start transmitting data, if the second buffer empties to an lower threshold.

14. The system of claim 13, wherein the data received from the Local Area Network is at a first data rate.

15. The system of claim 14, wherein the data transmitted from the Wide Area Network is at a second data rate.

16. The system of claim 15, wherein the first data rate is higher than the second data rate.

17. The system of claim 16, wherein the Local Area Network is an Ethernet network.

18. The system of claim 17, wherein the Wide Area Network is a Synchronous Optical Network or a Synchronous Digital Hierarchy network.
